(19) United States
(12) Patent Application Publication
(10) Pub. No.: US 2025/0206177 A1
(43) Pub. Date: Jun. 26, 2025

(54) ELECTRIFIED VEHICLE

(71) Applicant: TOYOTA JIDOSHA KABUSHIKI KAISHA, Toyota-shi (JP)

(72) Inventor: Akinori KITAZUME, Nagoya-shi (JP)

(73) Assignee: TOYOTA JIDOSHA KABUSHIKI KAISHA, Toyota-shi (JP)

(21) Appl. No.: 18/824,047

(22) Filed: Sep. 4, 2024

(30) Foreign Application Priority Data
Dec. 25, 2023 (JP) 2023-218341

(51) Int. Cl. B60L 53/66; B60L 50/60; B60L 53/16; B60L 53/62

(52) U.S. Cl. CPC B60L 53/66; B60L 50/60; B60L 53/16; B60L 53/62

(57) ABSTRACT

Electrified vehicle of the present disclosure includes a position information acquisition device that is capable of charging a battery with supply power supplied to a charging inlet from an external charging facility and charging a battery with power obtained by boosting the supply power on the vehicle side, and acquires position information of the external charging facility, a voltage of supply power of the external charging facility associated with the position information acquired by the position information acquisition device, and a charging control device that sets a voltage of the acquired supply power to a request voltage to be supplied from the external charging facility to the charging inlet, and notifies the external charging facility of the set request voltage.

### CROSS-REFERENCE TO RELATED APPLICATION

This application claims priority to Japanese Patent Application No. 2023-218341 filed on Dec. 25, 2023, incorporated herein by reference in its entirety.

### BACKGROUND

### 1. Technical Field

The present disclosure relates to an electrified vehicle capable of charging a battery with electric power supplied from external charging equipment.

### 2. Description of Related Art

Hitherto, there is known an electrified vehicle including a rechargeable battery and a charging controller and configured to travel with electric power of the battery (see, for example, Japanese Unexamined Patent Application Publication No. 2001-112181 (JP 2001-112181 A)). The charging controller of this electrified vehicle outputs (notifies) at least either of charging information and a charging algorithm to a charging station (external charging equipment) outside the vehicle. The charging information includes at least either of a charging current and a charging voltage unique to the battery. With the data supplied from the electrified vehicle, the charging station can determine an optimum charging voltage and an optimum charging current.

### SUMMARY

Electrified vehicles include an electrified vehicle in which electric power supplied from the charging station is boosted and a battery can be charged with the boosted electric power. This electrified vehicle may notify the charging station about the maximum voltage (rated voltage) permitted for charging the battery as the charging voltage (requested voltage). When the voltage of supply power of the charging station is lower than the voltage given as the notification from the electrified vehicle, determination is made that the voltage requested by the electrified vehicle cannot be supplied at the charging station. Therefore, there is a possibility that the battery cannot be charged. The electrified vehicle having the boosting function as described above may notify the charging station about the voltage to be supplied to the electrified vehicle from the charging station when the boosting function is used. In this case, the battery can be charged with the supply power from the charging station regardless of the magnitude of the voltage of the supply power of the charging station. When the charging station is capable of supplying a voltage higher than the voltage given as the notification from the electrified vehicle, however, the electrified vehicle performs the boosting control that was originally unnecessary. Therefore, the efficiency of charging the battery decreases.

Accordingly, the present disclosure suppresses inability of charging of a battery of an electrified vehicle with supply power of external charging equipment regardless of the magnitude of a voltage of the supply power. Further, the present disclosure has a main object to charge the battery efficiently.

An electrified vehicle of the present disclosure is an electrified vehicle including an electric motor configured to output traveling power, a battery configured to supply electric power to the electric motor, and a charging inlet. The electrified vehicle is configured to charge the battery with supply power supplied from external charging equipment to the charging inlet and to charge the battery with electric power obtained by boosting the supply power on the vehicle side. The electrified vehicle includes:
a position information acquisition device configured to acquire position information of the external charging equipment; and
a charging control device configured to acquire a voltage of the supply power of the external charging equipment associated with the position information acquired by the position information acquisition device, set the acquired voltage of the supply power as a requested voltage to be supplied from the external charging equipment to the charging inlet, and notify the external charging equipment about the set requested voltage.

The electrified vehicle of the present disclosure is configured to charge the battery with the supply power supplied from the external charging equipment to the charging inlet and to charge the battery with the electric power obtained by boosting the supply power on the vehicle side.

The charging control device of the electrified vehicle acquires the voltage of the supply power of the external charging equipment associated with the position information acquired by the position information acquisition device. The charging control device sets the acquired voltage of the supply power as the requested voltage to be supplied from the external charging equipment to the charging inlet, and notifies the external charging equipment about the set requested voltage.

Therefore, it is possible to suppress determination that the voltage that meets the requested voltage from the electrified vehicle cannot be supplied at the external charging equipment. Since the electrified vehicle grasps the voltage of the supply power of the external charging equipment, charging control can be performed based on the voltage of the supply power. Thus, the battery can be charged efficiently. As a result, it is possible to suppress inability of charging of the battery of the electrified vehicle with the supply power of the external charging equipment regardless of the magnitude of the voltage of the supply power, and to charge the battery efficiently.

Another electrified vehicle of the present disclosure is an electrified vehicle including an electric motor configured to output traveling power, a battery configured to supply electric power to the electric motor, and a charging inlet. The electrified vehicle is configured to charge the battery with supply power supplied from external charging equipment to the charging inlet and to charge the battery with electric power obtained by boosting the supply power on the vehicle side. The electrified vehicle includes:
a communication device configured to exchange information with an information management device configured to acquire charging history information on the external charging equipment including voltages of the supply power from a plurality of vehicles including the electrified vehicle and store the acquired charging history information; and a charging control device configured to acquire a voltage of the supply power of the external charging equipment from the information management device via the communication device, set the acquired voltage of the supply power as a requested voltage to be supplied from the external charging equipment to the charging inlet, and notify the external charging equipment about the set requested voltage.

The other electrified vehicle of the present disclosure is configured to charge the battery with the supply power supplied from the external charging equipment to the charging inlet and to charge the battery with the electric power obtained by boosting the supply power on the vehicle side.

The electrified vehicle includes the communication device configured to exchange information with the information management device configured to acquire the charging history information on the external charging equipment including the voltages of the supply power from the vehicles and store the acquired charging history information, and includes the charging control device.

The charging control device is configured to acquire the voltage of the supply power of the external charging equipment from the information management device via the communication device, set the acquired voltage of the supply power as the requested voltage to be supplied from the external charging equipment to the charging inlet, and notify the external charging equipment about the set requested voltage. Therefore, it is possible to suppress determination that the voltage that meets the requested voltage from the electrified vehicle cannot be supplied at the external charging equipment. Since the electrified vehicle grasps the voltage of the supply power of the external charging equipment, charging control can be performed based on the voltage of the supply power. Thus, the battery can be charged efficiently. As a result, it is possible to suppress inability of charging of the battery of the electrified vehicle with the supply power of the external charging equipment regardless of the magnitude of the voltage of the supply power, and to charge the battery efficiently.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating an electrified vehicle of the present disclosure;

FIG. 2 is an explanatory diagram for describing a process performed by electrified vehicle and the external charging facility prior to charging the battery of the disclosed electrified vehicle with the supplied power from the external charging facility;

FIG. 3 is a flow chart illustrating a routine executed by the charging control device of the disclosed electrified vehicle; and

FIG. 4 is a flow chart illustrating another routine executed by the charging control device of the disclosed electrified vehicle.

### DETAILED DESCRIPTION OF EMBODIMENTS

Embodiments of the present disclosure will now be described with reference to the drawings.

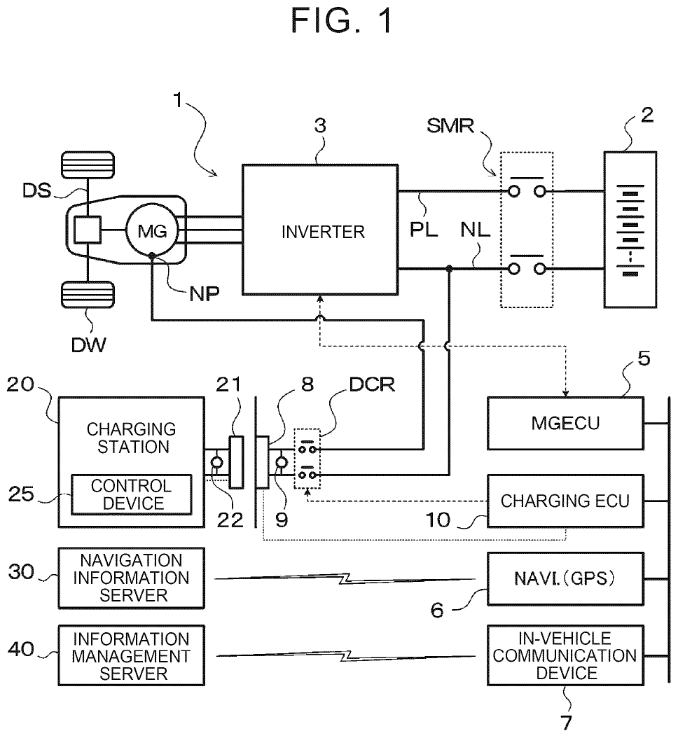

FIG. 1 is a schematic configuration diagram illustrating an electrified vehicle 1 of the present disclosure. Electrified vehicle 1 shown in the drawing is a battery electric vehicle (BEV) including a battery (power storage device) 2, a system main relay SMR, an inverter 3, and a motor generator MG. Further, electrified vehicle 1 includes a motor electronic control unit (hereinafter referred to as “MGECU”), a navigation device (position information acquisition device) 6, and an in-vehicle communication device 7, each 10 of which is connected to a CAN bus. Electrified vehicle 1 is configured to be able to charge the battery 2 by electric power from a DC-type charging station (external charging facility) 20. Electrified vehicle 1 may be plug-in hybrid electric vehicle (PHEV).

The battery 2 of electrified vehicle 1 has, for example, a rated output-voltage slightly lower than 800 V, and includes a plurality of battery modules (battery stacks) connected in series. Each battery module of the battery 2 includes a plurality of battery cells (not shown) connected in series or in parallel. Each battery cell is, for example, a lithium-ion secondary battery or a nickel-hydrogen secondary battery. The positive electrode side power line PL is connected to the positive electrode terminal of the battery 2 via the positive electrode side relay of the system main relay SMR. The negative electrode side power line NL is connected to the negative electrode terminal of the battery 2 via the negative electrode side relay of the system main relay SMR.

The inverter 3 drives the motor-generator MG, and is connected to the battery 2 via the positive-electrode-side power line PL, the negative electrode side power line NL, and the system main relay SMR. The inverter 3 includes, for example, six transistors and six diodes connected in parallel in opposite directions to the respective transistors, and is controlled (switched-controlled) by a MGECU 5. The motor-generator MG is a synchronous generator motor (three-phase AC motor). The rotor of the motor-generator MG is connected to the left and right drive wheel DW via a reduction gear, a differential gear, and a drive shaft DS. The motor-generator MG is driven by electric power from the inverter 3 (battery 2) and outputs a driving torque (driving force) for traveling to the drive shaft DS. Further, the motor-generator MG outputs regenerative braking torque (braking force) to the drive shaft DS when electrified vehicle 1 is braked.

The navigation device 6 includes a GPS receiver and the like, and is capable of specifying a vehicle position of electrified vehicle 1 and acquiring information related to the vehicle position. Further, the navigation device 6 can acquire, from the navigation information server 30, navigation information related to the destination of electrified vehicle 1 or the vehicle position by radio communication. The navigation information server 30 has a storage device that stores navigation information related to a plurality of spots in association with each other. The navigation information includes a charging condition such as a voltage Vs of the power supplied from the charging station 20 associated with the position information of the plurality of charging stations 20.

The in-vehicle communication device 7 enables high-speed data communication (wireless packet communication) with various external devices. In the present embodiment, the in-vehicle communication device 7 is capable of exchanging information with the information managing servers 40 that manage information collected from a large number of vehicles including electrified vehicle 1. The information management server 40 has a storage device that stores information collected from a large number of vehicles, and the information stored in the storage device includes charging history information transmitted from the vehicle using the charging station 20. The charging history information is obtained by linking the position information to the identification information of the charging station 20 and the charging conditions such as the voltage Vs of the supplied electric power supplied from the charging station 20 to electrified vehicle 1.

Further, electrified vehicle 1 includes a charging relay DCR, a charging inlet 8, and a charging electronic control unit (hereinafter, referred to as a “charging ECU”) 10 to enable the battery 2 to be charged by electric power from the charging station 20. The charging relay DCR is connected to the neutral point NP of the motor generator MG via the power line, and is connected to the negative electrode side power line NL between the system main relay SMR and the inverter 3 via the power line. The charging inlet 8 is disposed inside a charging lid (not shown) of electrified vehicle 1, and is connected to the charging-relay DCR via a power line. Thus, when both the system main relay SMR and the charging relay DCR are closed, the battery 2 is electrically connected to the charging inlet 8 via the motor generator MG and the inverter 3. Then, the charging connector 21 of the charging station 20 selected by the user of electrified vehicle 1 is inserted into the charging inlet 8 from among the plurality of charging stations 20 (connected)

The charging ECU 10 includes a microcomputer having a CPU, a ROM, RAM, a storage device, and the like (not shown). The charging ECU 10 is connected to a CAN bus, and can exchange various types of data with MGECU 5, the navigation device 6, and the in-vehicle communication device 7 via CAN bus. The charging ECU 10 opens and closes the charging-relay DCR. At the same time, when the battery 2 is charged by the electric power from the charging station 20, the charging ECU 10 causes the three-phase coils of the motor-generator MG and the respective phases of the inverter 3 to function as the multi-phase step-up converter as needed. This is done in cooperation with MGECU 5. That is, in electrified vehicle 1, when the battery 2 is charged with electric power from the charging station 20, a plurality of transistors of the inverter 3 is switched and controlled. As a result, the electric power supplied to the charging inlet 8 is boosted by the motor generator MG and the inverter 3 as the multi-phase boost converters, and the boosted electric power can be applied to the battery 2.

The plurality of charging stations 20 are DC-type charging stations. A low voltage stand in which the voltage Vs of the supplied power is a first voltage Vlow (e.g., 400 V) and a high voltage stand are included. The high voltage station can selectively set one of the first voltage Vlow and the second voltage Vhigh (e.g., 800 V) higher than the first voltage Vlow as the voltage Vs of the supplied power. It is conceivable that the voltage Vs of the supply power supplied from the charging station 20 to the charging inlet 8 via the charging connector 21 is the first voltage Vlow. In this embodiment, the motor generator MG and the inverter 3 as the polyphase step-up converter can step up the power supplied from the charging station 20 to a voltage equal to or higher than the rated output voltage of the battery 2 (for example, 800 V). The charging station 20 includes, in addition to the charging connector 21, a stand control device 25 that exchanges information with electrified vehicle 1 and controls the electric power equipment and the like of the charging station 20. The stand control device 25 includes a microcomputer or the like having a CPU, a ROM, RAM, a storage device, or the like (not shown). When the charging connector 21 of the charging station 20 is connected to the charging inlet 8 of electrified vehicle 1, the stand control device 25 is connected to the charging ECU 10 of electrified vehicle 1 via a communication line (see dotted line in FIG. 1).

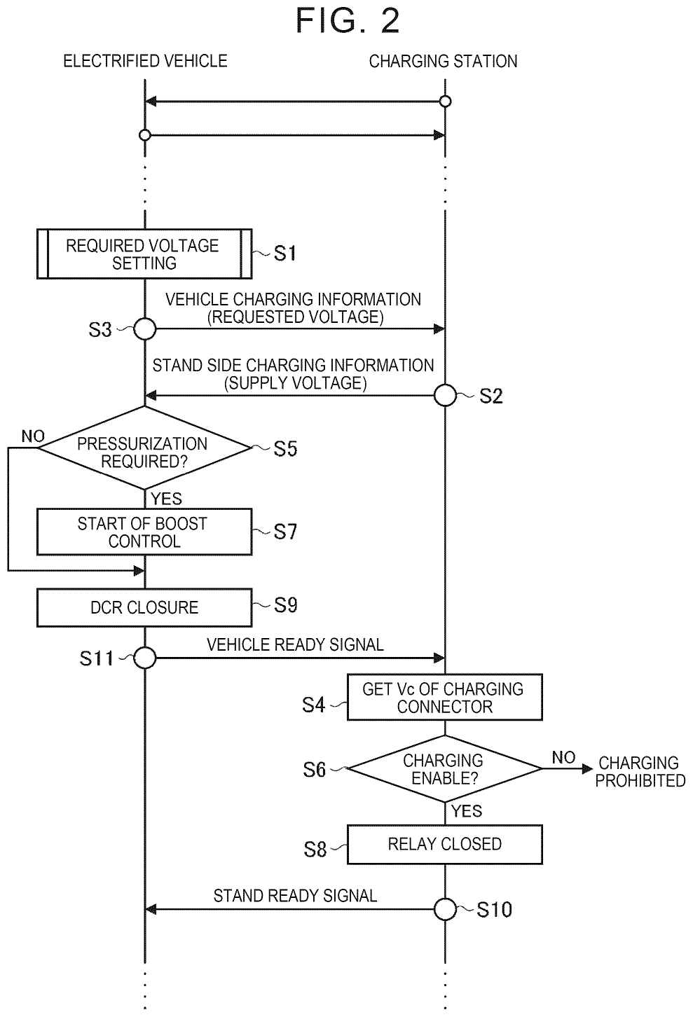

FIG. 2 is a flow chart for describing a process executed by electrified vehicle 1 and the charging station 20 after electrified vehicle 1 stops at the charging station 20 and the charging connector 21 is connected to the charging inlet 8 until the charging of the battery 2 is started. As shown in the drawing, electrified vehicle 1 charging ECU 10 and the stand control device 25 of the charging station 20 can communicate with each other. Then, predetermined information is exchanged between the two, and the system main relay SMR of electrified vehicle 1 is closed by the charging ECU 10. Further, the charging ECU 10 sets a required voltage Vreq for the charging station 20 at a predetermined timing after the charging connector 21 is connected to the charging inlet 8 (S1). The required voltage Vreq is a voltage to be supplied from the charging station 20 to the charging inlet 8 when the battery 2 is charged.

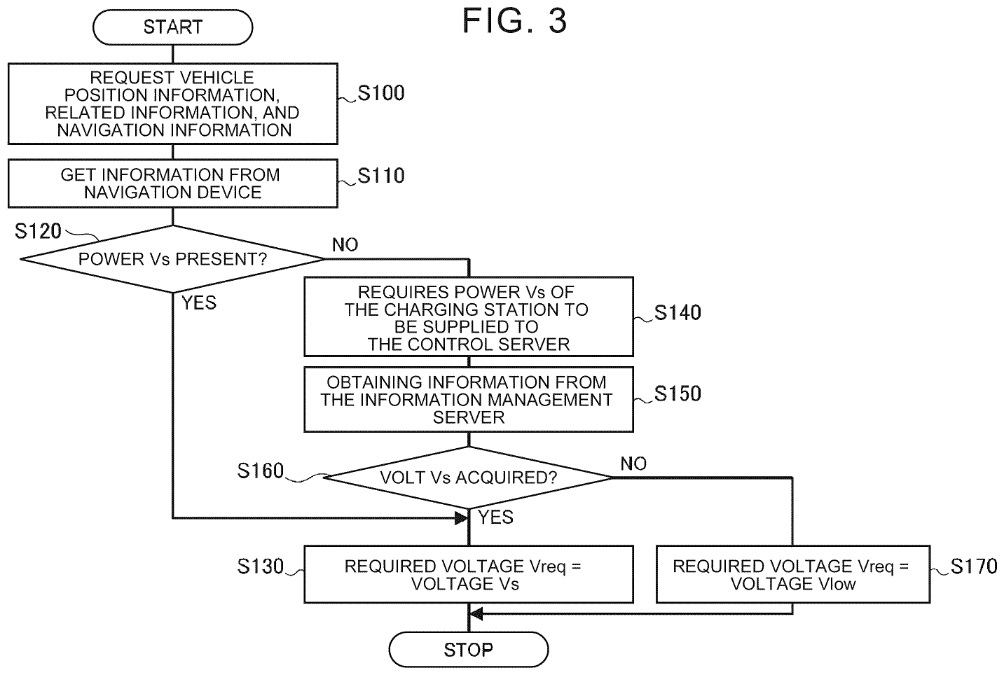

When setting the required-voltage Vreq, as shown in FIG. 3, the charging ECU 10 requests the navigation device 6 to provide the own-vehicle position information of electrified vehicle 1 indicating the position of the charging station 20, information related to the own-vehicle position, and navigation information (S100). Further, the charging ECU 10 acquires information transmitted from the navigation device 6 in response to the request (S110), and determines whether or not the acquired information includes a voltage Vs of the supplied power supplied from the charging station 20 to the charging inlet 8 (S120). When the voltage Vs of the power supplied by the charging station 20 is included in the information from the navigation device 6 (S120: YES), the charging ECU 10 sets the voltage Vs acquired from the navigation device 6 to the required voltage Vreq for the charging station 20 (S130), and completes the setting of the required voltage Vreq. In the present embodiment, in S130, one of the first and second voltage Vlow, Vhigh is set to the required voltage Vreq.

When the information from the navigation device 6 does not include the voltage Vs of the power supplied by the charging station 20 (S120: NO), the charging ECU 10 transmits the own vehicle position information of electrified vehicle 1 or the separately acquired identification information of the charging station 20 to the information managing server 40. The own-vehicle position data is acquired by S110 via the in-vehicle communication device 7. Then, the charging ECU 10 requests the information-managing server 40 to provide the voltage Vs of the power supplied from the charging station 20 (S140). The information managing server 40 searches for the voltage Vs of the supply power of the corresponding charging station 20 from the above-described charge history information, and transmits the search result to electrified vehicle 1 in-vehicle communication device 7. The charging ECU 10 acquires information from the information management server 40 via the in-vehicle communication device 7 (S150), and determines whether or not the voltage Vs of the power supplied from the charging station 20 has been acquired from the information management server 40 (S160).

When the voltage Vs of the power supplied from the charging station 20 is acquired from the information management server 40 (S160: YES), the charging ECU 10 sets the voltage Vs acquired from the information management server 40 to the required voltage Vreq for the charging station 20 (S130), and completes the setting of the required voltage Vreq. On the other hand, when the voltage Vs of the supply power of the charging station 20 is not included in the information from the navigation device 6 (S120: NO) and the voltage Vs of the supply power of the charging station 20 is not acquired from the information managing server 40 (S160: NO), the charging ECU 10 sets the first voltage Vlow to the request voltage Vreq (S170) and completes the setting of the request voltage Vreq. The first voltage Vlow is the lowest of the first and second voltage Vlow, Vhigh.

After S1 process, the charging ECU 10 transmits the vehicle-side charging data to the stand control device 25 of the charging station 20 as shown in FIG. 2 (S3). The vehicle-side charging data includes at least the required voltage Vref set by S1, and the charging ECU 10 notifies the stand control device 25 of the required voltage Vref as a voltage Vin at the charging inlet 8. After receiving the vehicle-side charging information, the stand control device 25 performs a predetermined process, and then transmits the stand-side charging information to electrified vehicle 1 charging ECU 10 (S2). The stand-side charge data includes at least a voltage Vs (here, 400 V or 800 V) of the power supplied from the charging station 20 to the charging inlet 8.

Upon receiving the stand-side charging data from the charging station 20, the charging ECU 10 determines whether or not the step-up control needs to be executed (S5). The boosting control is for boosting the voltage supplied from the charging station 20 to the charging inlet 8 based on the required voltage Vreq set by S1. In S5, when the first voltage Vlow lower than the second voltage Vhigh is set to the required voltage Vreq in S1, the charging ECU 10 determines that the voltage supplied from the charging station 20 to the charging inlet 8 needs to be boosted (S5: YES). Then, the charging ECU 10 transmits a command signal to MGECU 5 to execute boost control for operating the motor generator MG and the inverter 3 as a multiphase boost converter (S7). As a result, the motor generator MG and the inverter 3 as the polyphase step-up converter operate so that the voltage on the charging relay DCR is lower (stepped down) than the voltage between terminals of the battery 2. In the present embodiment, the motor generator MG and the inverter 3 are controlled so as to lower the voltage between terminals of the battery 2 so that the voltage on the charging relay DCR matches the first voltage Vlow (400 V). When the second voltage Vhigh is set to the required voltage Vreq in S1, the charging ECU 10 determines that the voltage supplied from the charging station 20 to the charging inlet 8 does not need to be boosted (S5: NO), and skips S7 process.

After S5 or S7 process, the charging ECU 10 closes the charging relay DCR (S9). After the completion of the closing of the charging-relay DCR, the charging ECU 10 executes a predetermined process and transmits a vehicle-ready signal indicating that the charging-ready state is completed in electrified vehicle 1 to the stand control device 25 of the charging station 20 (S11). Upon receiving the vehicle-ready completion signal, the stand control device 25 acquires the voltage Vc of the charging connector 21 detected by the voltage sensor 22 of the charging station 20 (S4). Further, the stand control device 25 determines whether or not to allow electrified vehicle 1 battery 2 to be charged (S6). In S6, the stand control device 25 determines whether or not the required voltage Vreq is included in a relatively narrow predetermined range (for example, a range of +5%) centered on the voltage Vc in the charge connector 21 acquired by S6. The required voltage Vreq is a voltage Vin at the charging inlet 8 included in the vehicle-side charging data from the charging ECU 10 (electrified vehicle 1). At the same time, the stand control device 25 determines whether the voltage Vin exceeds the minimum output voltage of the charging station 20 and is less than the maximum output voltage of the charging station 20.

When the voltage Vin is not included in the predetermined range around the voltage Vc, when the voltage Vin is less than the minimum output voltage of the charging station 20, and when the voltage Vin exceeds the maximum output voltage of the charging station 20 (S6: NO), the stand control device 25 prohibits the charging of the battery 2 of electrified vehicle 1 by assuming that a voltage corresponding to the required voltage Vreq of electrified vehicle 1 cannot be supplied from the charging station 20. On the other hand, when the voltage Vin is included within a predetermined range centered on the voltage Vc, the voltage Vin is equal to or higher than the minimum output voltage of the charging station 20, and the voltage Vin is equal to or lower than the maximum output voltage of the charging station 20 (S6: YES), the stand control device 25 considers that a voltage corresponding to electrified vehicle 1 required voltage Vreq can be supplied from the charging station 20 and permits the charging of the battery 2 of electrified vehicle 1. Furthermore, the stand control device 25 controls a power device (not shown) so as to supply power of a voltage Vs corresponding to the required voltage Vreq from electrified vehicle 1. At the same time, the stand control device 25 closes a relay (not shown) provided between the electric power device and the charge connector 21 (S8). After the closing of the relay is completed, the stand control device 25 transmits a stand preparation completion signal indicating that the charging preparation is completed in the charging station 20 to the charging ECU 10 (S10). As a result, electric power is supplied from the charging station 20 to electrified vehicle 1 charging inlet 8, and charging of the battery 2 is started.

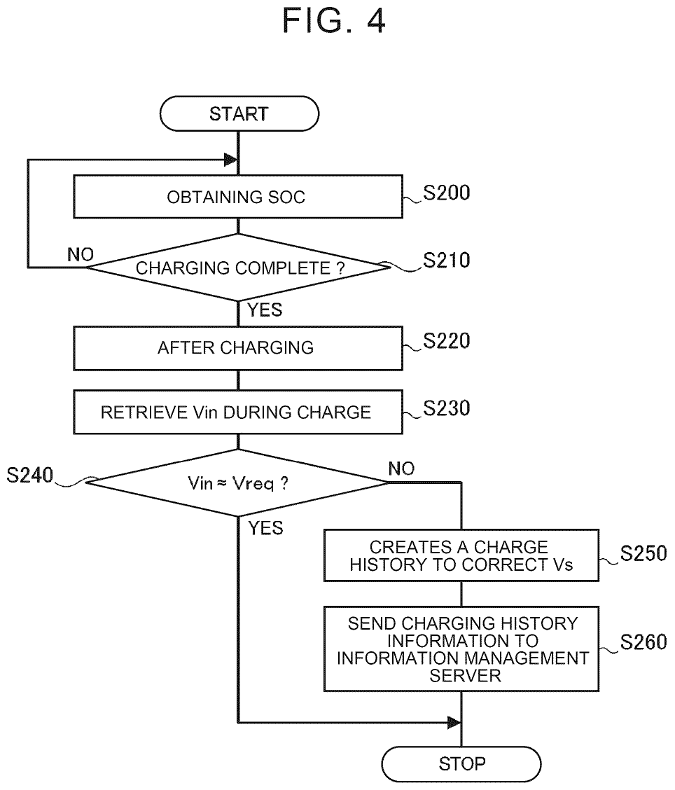

During charging of the battery 2, as shown in FIG. 4, the charging ECU 10 acquires SOC of the battery 2 calculated by a battery managing device (not shown) of electrified vehicle 1 at predetermined intervals (S200). Then, the charging ECU 10 determines whether or not the obtained SOC reaches a predetermined target SOC and charging of the battery 2 is completed (S210). When SOC has not reached the target SOC and the charging of the battery 2 has not been completed (S210: NO), the charging ECU 10 continues the charging of the battery 2 and executes S20 and $210 processes at predetermined intervals. Further, when the first voltage Vlow is set to the required voltage Vreq at S1 (S130 or S170), the motor generator MG and the inverter 3 as the multiphase step-up converter are controlled so as to step up the voltage Vs of the supply power supplied from the charging station 20 to the charging inlet 8 to the rated output voltage or higher of the battery 2 during charging of the battery 2.

When SOC reaches the target SOC and the charging of the battery 2 is completed (S210: YES), the charging ECU 10 executes a post-charging process (S220). The post-charge completion process includes opening the charging relay DCR, stopping the boosting, opening the system main relay, exchanging various types of information with the stand control device 25, and the like. After completion of the charging completion process, the charging ECU 10 acquires the voltage Vin at the charging inlet 8 detected by the voltage sensor 9 (see FIG. 1) during charging of the battery 2, that is, the voltage (actual voltage) of the supply power supplied from the charging station 20 to the charging inlet 8 (S230). The voltage Vin acquired by S230 may be detected by the voltage sensor 9 at a predetermined timing during charging of the battery 2, or may be an averaged voltage Vin during charging of the battery 2. Further, the charging ECU 10 determines whether or not the voltage Vin acquired by S230 is included in a relatively narrow predetermined area centered on the required voltage Vreq (S240). When the voltage Vin is included within a predetermined range centered on the required voltage Vreq and the voltage Vin substantially matches the required voltage Vreq (S240: YES), the series of processes illustrated in FIGS. 2, 3, and 4 is terminated.

On the other hand, when the voltage Vin in the charging inlet 8 acquired by S230 is not included within a predetermined range centered on the required voltage Vreq (S240: NO), a voltage that substantially matches the required voltage Vreq is not supplied from the charging station 20 to the charging inlet 8 during charging of the battery 2. In other words, the required-voltage Vreq set by S130 is incorrect. The required voltage Vreq set in S130 is the voltage Vs of the supplied power of the charging station 20 acquired from the navigation device 6 or the information-management-server 40 in S110 or S150 of FIG. 2. Therefore, one of the first and second voltage Vlow, Vhigh that differs from the required voltage Vreq set by S130 is used as a correct voltage Vs (correction value) by the charging ECU 10 to create charging history information associated with the own vehicle position information (identification information of the charging station 20) of electrified vehicle 1 corresponding to the position information of the charging station 20 (S250). Further, the charging ECU 10 transmits the charging history information created by S250 to the information managing servers 40 (S260), and ends the series of processes illustrated in FIGS. 2, 3, and 4.

As described above, electrified vehicle 1 includes a motor generator MG for outputting driving power, a battery 2 for supplying electric power to the motor generator MG, and a charging inlet 8. Electrified vehicle 1 can charge the battery 2 with the supplied electric power supplied from the charging station 20 to the charging inlet 8, and can charge the battery 2 with the electric power obtained by boosting the supplied electric power in the vehicle. Electrified vehicle 1 also includes a navigation device (position information acquisition device) 6 capable of acquiring position information (own vehicle position information) of the charging station 20, and a charging ECU (charging control device) 10. The charging ECU 10 acquires the voltage Vs of the supplied power of the charging station 20 associated with the position information acquired by the navigation device 6 (S1, S110, S150). At the same time, the voltage Vs of the acquired supplied power is set to the required voltage Vreq to be supplied from the charging station 20 to the charging inlet 8 (S130), and the set required voltage Vreq is notified to the charging station 20 (S3).

As a result, it is possible to suppress the charging station 20 from determining that a voltage corresponding to the required voltage Vreq from electrified vehicle 1 cannot be supplied. Further, electrified vehicle 1 can execute the charge control according to the voltage Vs of the supply power by grasping the voltage Vs of the supply power of the charging station 20. Therefore, for example, even though the voltage of the supplied power supplied to the charging inlet 8 is 800 V, the step-up control is suppressed from being executed unnecessarily, and the battery 2 can be charged efficiently. Consequently, irrespective of the magnitude of the voltage Vs of the supply power of the charging station 20, electrified vehicle 1 battery 2 cannot be charged by the supply power. At the same time, the battery 2 can be charged efficiently.

Further, electrified vehicle 1 includes an in-vehicle communication device 7, and the in-vehicle communication device 7 acquires charge history data including voltage Vs of the power supplied from the charging station 20 from a plurality of vehicles including electrified vehicle 1. At the same time, electrified vehicle 1 exchanges information with the information managing servers 40 that store the acquired charge history information. Then, the charging ECU 10 can acquire the voltage Vs of the power supplied from the charging station 20 from the information-management-server 40 via the in-vehicle communication device 7 (S140-S150). Thus, even when the voltage Vs of the supply power of the charging station 20 is not associated with the position information of the charging station 20 (S120: NO), the voltage Vs of the supply power can be acquired from the information managing servers 40.

Further, when the voltage Vs of the supply power of the charging station 20 cannot be acquired from the navigation device 6 or the information-management server 40 ($120: NO, S160: NO), the charging ECU 10 notifies the charging station 20 of the first voltage Vlow to be supplied from the charging station 20 to the charging inlet 8 as the required voltage Vref when the battery 2 is charged with the electric power obtained by boosting the supply power from the charging station 20 (S170). Thus, even when the voltage Vs of the supplied power of the charging station 20 cannot be acquired, it is possible to suppress the battery 2 from becoming incapable of being charged.

Further, the charging ECU 10 acquires a voltage (actual voltage) Vin supplied from the charging station 20 to the charging inlet 8 during charging of the battery 2 (S230). At the same time, the charging ECU 10 determines, based on the voltage Vin, whether or not the voltage Vs of the supplied power of the charging station 20 acquired in S1 (S110 or S150) prior to charging of the battery 2 is appropriate (S240). Further, when it is determined that the voltage Vs of the supplied power of the charging station 20 is not appropriate (S240: NO), the charging ECU 10 transmits the charging history information including the correction value of the voltage Vs corresponding to the position information (identification information) and the voltage Vin (actual voltage) of the charging station 20 to the information managing server 40 (S250-S260). This makes it possible to update the charge history information stored by the information management server 40 to a useful one in accordance with the actual condition.

When setting the required voltage Vreq in S1, the voltage Vs of the power supplied from the charging station 20 is not necessarily acquired from both the navigation device 6 and the information-management-server 40. The processing of S100-S120 or the processing of S120, S140 and S150 of FIG. 3 may be omitted. That is, the charging ECU 10 acquires the voltage Vs of the power supplied by the charging station 20 from only one of the navigation device 6 and the information-management-server 40. In addition, the charging ECU 10 may set the voltage Vs of the obtained supplied power to the required voltage Vreq to be supplied from the charging station 20 to the charging inlet 8. According to these aspects as well, it is possible to suppress electrified vehicle 1 battery 2 from becoming incapable of being charged by the supplied power regardless of the magnitude of the voltage Vs of the supplied power of the charging station 20, and to efficiently charge the battery 2.

In addition, the setting of the required voltage Vreq in S1 may be performed prior to S3 of the vehicle-side charging data from electrified vehicle 1 to the charging station 20. It does not necessarily have to be carried out after the charging connector 21 of the charging station 20 is connected to the charging inlet 8 of electrified vehicle 1. That is, for example, the charging station 20 may be set as a destination of the navigation device 6 by a user of electrified vehicle 1. In this case, S1 process may be executed from the setting of the destination until electrified vehicle 1 arrives at the charging station 20. Further, in S260 of FIG. 4, the charge history information may be transmitted to the navigation information server 30 in addition to the information managing server 40. This makes it possible to update the navigation information stored by the navigation information server 30 to a useful one in accordance with the actual condition. Further, electrified vehicle 1 is not limited to charging the battery 2 by so-called neutral point charging as long as it charges the battery 2 by electric power obtained by boosting electric power from an external charging facility on the vehicle-side.

It is needless to say that the disclosure of the present disclosure is not limited to the above-described embodiments, and various modifications can be made within the scope of the extension of the present disclosure. Furthermore, the above-described embodiment is only a specific form of the disclosure described in the column of the outline of the disclosure, and does not limit the elements of the disclosure described in the column of the outline of the disclosure.

The present disclosure is applicable to the manufacturing industry of electrified vehicle and the like.

What is claimed is:

1. An electrified vehicle including an electric motor configured to output traveling power, a battery configured to supply electric power to the electric motor, and a charging inlet, the electrified vehicle being configured to charge the battery with supply power supplied from external charging equipment to the charging inlet and to charge the battery with electric power obtained by boosting the supply power on the vehicle side, the electrified vehicle comprising:
a position information acquisition device configured to acquire position information of the external charging equipment; and
a charging control device configured to acquire a voltage of the supply power of the external charging equipment associated with the position information acquired by the position information acquisition device, set the acquired voltage of the supply power as a requested voltage to be supplied from the external charging equipment to the charging inlet, and notify the external charging equipment about the set requested voltage.

2. The electrified vehicle according to claim 1, further comprising a communication device configured to exchange information with an information management device configured to acquire charging history information including voltages of the supply power of the external charging equipment from a plurality of vehicles including the electrified vehicle and store the acquired charging history information, wherein the charging control device is configured to acquire the voltage of the supply power of the external charging equipment from the information management device via the communication device.

3. The electrified vehicle according to claim 2, wherein the charging control device is configured to, when the voltage of the supply power is not acquirable, notify the external charging equipment about, as the requested voltage, a voltage to be supplied from the external charging equipment to the charging inlet when charging the battery with the electric power obtained by boosting the supply power.

4. The electrified vehicle according to claim 2, wherein the charging control device is configured to acquire an actual voltage supplied from the external charging equipment to the charging inlet during charging of the battery, determine, based on the actual voltage, whether the voltage of the supply power of the external charging equipment acquired before the charging of the battery is appropriate, and transmit, when determination is made that the voltage of the supply power of the external charging equipment is not appropriate, charging history information including identification information of the external charging equipment and a correction value for the voltage of the supply power based on the actual voltage to the information management device.

5. An electrified vehicle including an electric motor configured to output traveling power, a battery configured to supply electric power to the electric motor, and a charging inlet, the electrified vehicle being configured to charge the battery with supply power supplied from external charging equipment to the charging inlet and to charge the battery with electric power obtained by boosting the supply power on the vehicle side, the electrified vehicle comprising:
a communication device configured to exchange information with an information management device configured to acquire charging history information on the external charging equipment including voltages of the supply power from a plurality of vehicles including the electrified vehicle and store the acquired charging history information; and
a charging control device configured to acquire a voltage of the supply power of the external charging equipment from the information management device via the communication device, set the acquired voltage of the supply power as a requested voltage to be supplied from the external charging equipment to the charging inlet, and notify the external charging equipment about the set requested voltage.
